(19) United States
(12) Patent Application Publication
(10) Pub. No.: US 2026/0122048 A1
(43) Pub. Date: Apr. 30, 2026

(54) ROBUST METHODS FOR DYNAMIC RESOURCE ALLOCATION OF REMOTE SYSTEMS

(71) Applicant: T-Mobile USA, Inc., Bellevue, WA (US)

(72) Inventor: Murugappan Palaniappan, Issaquah, WA (US)

(21) Appl. No.: 18/925,019

(22) Filed: Oct. 24, 2024

(51) Int. Cl. H04L 9/40

(52) U.S. Cl. CPC H04L 63/08

(57) ABSTRACT

Systems and methods comprising instructions to receive a request of an end-user to utilize an application administered by an enterprise customer subscribed to a telecommunications network through which the application is hosted, perform a runtime authorization procedure in response to the request to determine whether the end-user is authorized to utilize the set of service features in accordance with a user profile and based on preference parameters set for the enterprise subscriber, dynamically allocate a service feature of the set of service features authorized for use by the end-user in response to determining that the end-user is authorized to utilize the set of service features, and record usage of the service feature by the end-user to an account of the enterprise subscriber stored at a charging system of the telecommunications network.

### BACKGROUND

Identity management (IdM), also known as identity and authentication management (IAM or IdAM), is a framework of policies and technologies to ensure that the right users (that are part of the ecosystem connected to or within an enterprise) have the appropriate access to technology resources. IdM systems fall under the overarching umbrellas of IT security and data management. Identity and authentication management systems not only identify, authenticate, and control access for individuals who will be utilizing IT resources but also the hardware and applications employees need to access.

Network provisioning, or service mediation, refers to the provisioning of customer services to network elements (e.g., of a telecommunications network), which are various equipment connected in that network communication system. In general, provisioning in telephony is accomplished with network management database table mappings. It requires the existence of networking equipment and depends on network planning and design.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a resource allocation system that can implement aspects of the present technology.

FIG. 4 is a block diagram that illustrates a process for provisioning network resources in some implementations.

FIG. 5 is a block diagram that illustrates a process for dynamic network resource allocation in some implementations.

FIG. 6 is a block diagram that illustrates a process for generating resource usage reports in some implementations.

FIG. 7 is a flow diagram that illustrates a process to dynamically allocate application services in some implementations.

FIG. 8 is a flow diagram that illustrates a process to record usage of application services in some implementations.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein are systems and related methods for dynamic allocation and management of resources (e.g., computational processes, power consumption, and/or the like) enabling authorized users to access remote hosted (e.g., telecommunications network) applications and/or services. The disclosed system can generate custom authorization profiles comprising unique resource usage limitations (e.g., maximum service duration) for subscribing users of an enterprise application. Accordingly, the disclosed system further enables enterprise-level subscribers (e.g., service developers) to deploy custom resource allocation strategies and consumer billing structures.

The disclosed system can generate custom end-user authorization profiles based on usage limitations (e.g., of a network hosted application) imposed by an enterprise subscriber. As an illustrative example, the disclosed system enables enterprise subscribers (e.g., application developers, software distributors, and/or the like) to host remote application services (e.g., via a telecommunications network). The system further enables the enterprise subscribers to define usage restrictions (e.g., maximum time allotted per user, maximum concurrent users, and/or the like) that limit allocation of network resources for servicing different types of end-users. In particular, the system can generate personalized user profiles that authorize end-users to allocate network resources to facilitate specified application services. Accordingly, the system can respond to an external user request for running a remote application service (e.g., via the telecommunications network) by identifying a corresponding user profile to authenticate user permissions for allocating network resources.

In some aspects, the system can dynamically allocate (e.g., or deallocate) resources to provide remote hosted application services for authorized users. For example, the system can evaluate an authorization profile of a requesting user to determine eligibility of the user to allocate resources for running application services. Upon confirming user eligibility, the system can allocate resources to run the requested application and initiate real-time monitoring (e.g., a charging session recorded via an application programming interface (API)) of resource usage by the requesting user. As a result, the system can detect when authorized users have exhausted their allocated resources and are no longer eligible for additional resource allocation under the usage limitations set by the enterprise subscriber.

In other aspects, the system can create custom resource utilization reports that enable flexible record-keeping for resource consumption of remote hosting services (e.g., telecommunications networks). For example, the system can instantiate a dynamic charging session that records several types of resource consumption (e.g., network data usage, frequent API requests, and/or the like) incurred while hosting an application service (e.g., of an enterprise subscriber). As a result, the system enables authorized users (e.g., the enterprise subscriber, a network service provider, a billing system, and/or the like) to deploy custom charging configurations and/or schemas. As an illustrative example, an authorized user can configure charging sessions of the runtime application service to distribute resource consumption costs of a first consumption type (e.g., network data usage) to a first liable entity (e.g., an end-user) and a second consumption type (e.g., API requests) to a second liable entity (e.g., an enterprise subscriber, a developer) associated with the application service. Using the custom charging configuration, the system can further communicate with external billing systems (e.g., end-to-end billing systems, revenue management technologies) to transmit resource utilization reports (e.g., cumulative fees, billing structures, and/or the like) corresponding to each liable entity (e.g., an enterprise subscriber, an end-user).

Advantages of the disclosed technology include a robust authentication mechanism for allocating (e.g., or deallocating) available resources of a runtime application service, such as by leveraging custom end-user profiles (e.g., identifiable user information) and administrative preferences (e.g., usage limitations). As a result, the disclosed technology enables enterprise subscribers of remote application services (e.g., application administrators) to implement sophisticated and granular methods of monitoring resource consumption, restricting resource usage, and partitioning costs of resource consumption (e.g., maintenance costs of network, usage fee, and/or the like) across multiple involved parties (e.g., the end-user, the enterprise subscriber, the network provider, and/or the like). Accordingly, the disclosed technology further enables enterprise subscribers to exercise significant flexibility in generating custom resource utilization reports and billing configurations.

For illustrative purposes, some examples of systems and methods are described herein in the context of dynamic resource allocation systems for hosting remote application services via telecommunications networks. However, a person skilled in the art will appreciate that the disclosed system can be applied in other contexts. As an example, the disclosed system can be used within distributed computing systems to dynamically manage allocation of remote computational resources (e.g., cloud-computing resources). In another example, the disclosed system can be used within software communication services (e.g., APIs) to generate dynamic cost-tracking tools (e.g., a subscription, a trial, an on-demand cost, and/or the like) associated with service consumption.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

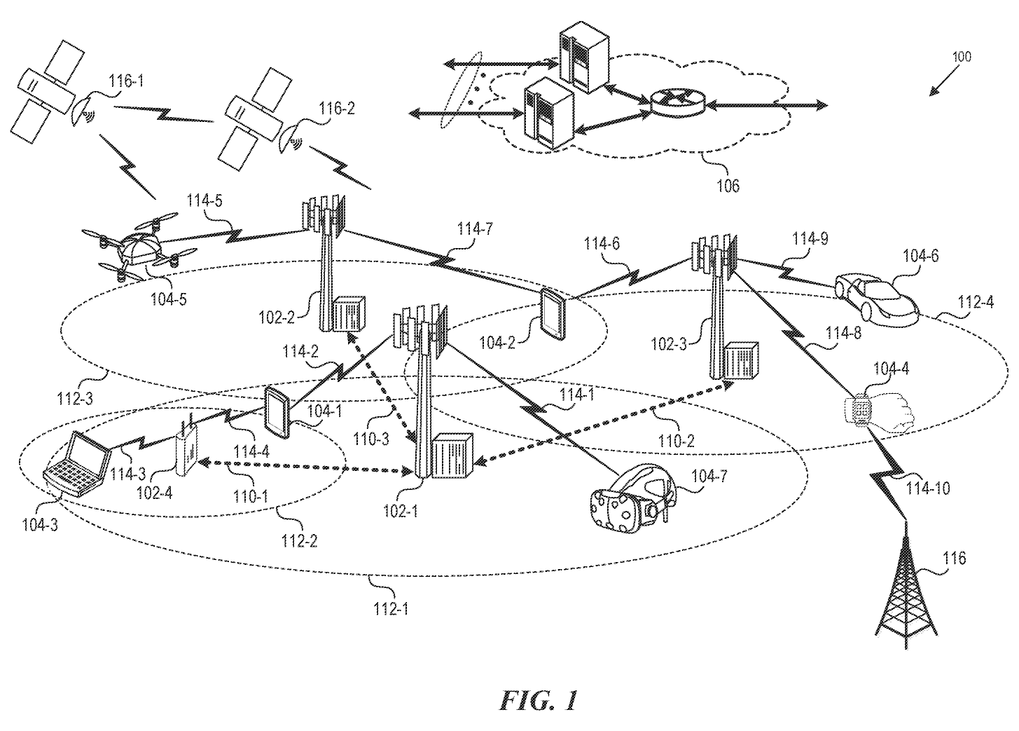

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104” or alternatively as “user device 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

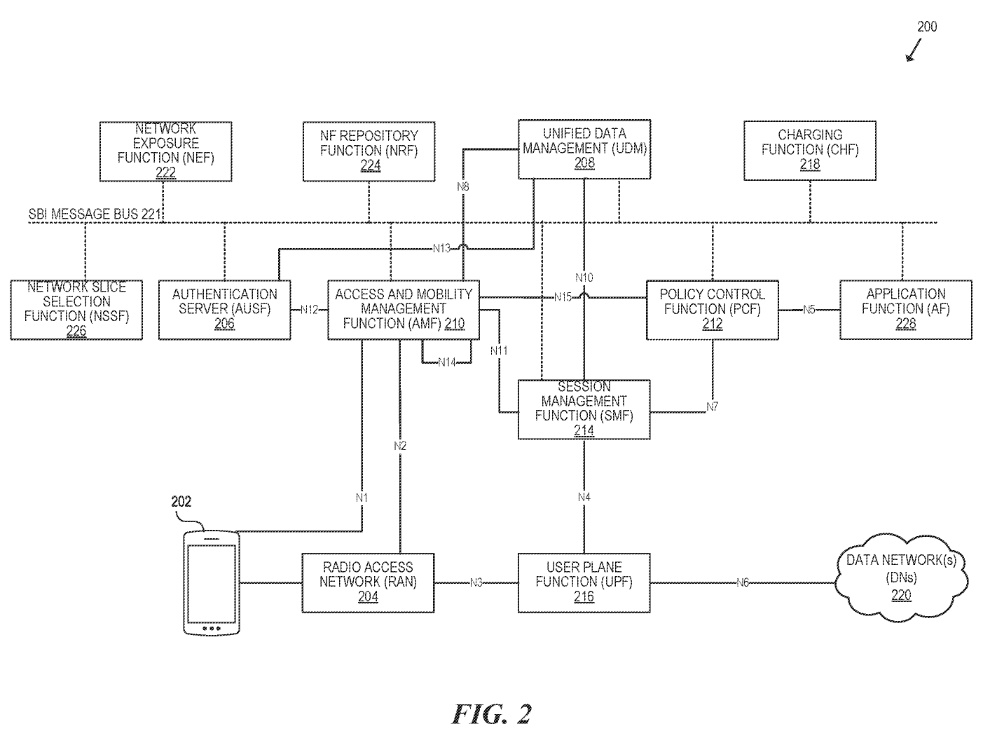

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Resource Allocation System

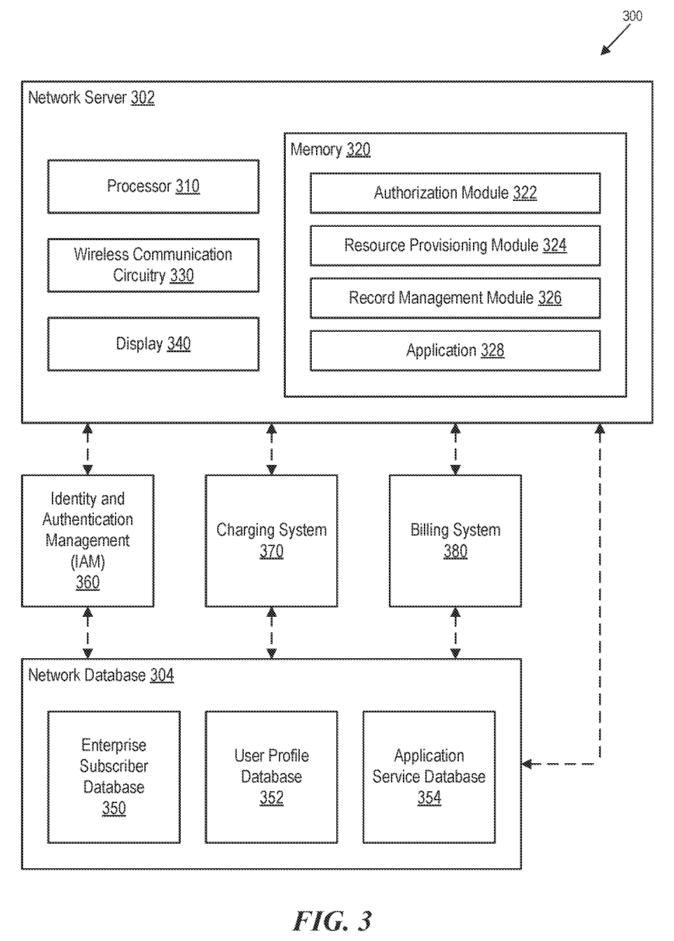

FIG. 3 is a block diagram that illustrates a resource allocation system 300 (“resource allocation system 300” or “system 300”) that can implement aspects of the present technology. The components shown in FIG. 3 are merely illustrative, and well-known components are omitted for brevity. As shown, the network server 302 includes a processor 310, a memory 320, a wireless communication circuitry 330 to establish wireless communication and/or information channels (e.g., Wi-Fi, internet, APIs, communication standards) with other computing devices and/or services (e.g., servers, databases, cloud infrastructure), and a display 340 (e.g., user interface). The processor 310 can have generic characteristics similar to general-purpose processors, or the processor 310 can be an application-specific integrated circuit (ASIC) that provides arithmetic and control functions to the network server 302. While not shown, the processor 310 can include a dedicated cache memory. The processor 310 can be coupled to all components of the network server 302, either directly or indirectly, for data communication. Further, the processor 310 of the network server 302 can be communicatively coupled to a network database 304 that is hosted alongside the network server 302 on the core network 106 described in reference to FIG. 1. As shown, the network database 304 can include an enterprise subscriber database 350, a user profile database 352, and an application service database 354.

The memory 320 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 310, the memory 320 can also store data generated by the processor 310 (e.g., when executing the modules of an optimization platform). In additional, or alternative, embodiments, the processor 310 can store temporary information onto the memory 320 and store long-term data onto the network database 304. The memory 320 is merely an abstract representation of a storage environment. Hence, in some embodiments, the memory 320 comprises one or more actual memory chips or modules.

As shown in FIG. 3, modules of the memory 320 can include an authorization module 322, a resource provisioning module 324, a record management module 326, and a runtime application 328 (referred to as “application 328” or “application services 328” or “runtime application services 328”). Other implementations of the network server 302 include additional, fewer, or different modules, or distribute functionality differently between the modules. As used herein, the term “module” refers broadly to software components, firmware components, and/or hardware components. Accordingly, the modules 322, 324, 326, 328 could each comprise software, firmware, and/or hardware components implemented in, or accessible to, the network server 302.

In some implementations, components of the network server 302 can be communicatively coupled to an identity and authentication management (IAM) system 360. The network server 302 can configure the IAM system 360 to manage user identification credentials and access permissions for one or more application services 328 hosted via the telecommunications network. Accordingly, the IAM system 360 can be configured to allow only authorized users in accessing network resources (e.g., allocatable network resources) and runtime application services 328. As an illustrative example, the network server 302 can configure the IAM system 360 to evaluate a set of identification parameters (e.g., official name, password, location, network access origin, and/or the like) corresponding to a requesting end-user of application services 328 hosted via the telecommunications network. For instance, the IAM system 360 can use the set of identification parameters to search for at least one user authentication profile (e.g., accessible permissions for the requesting end-user) from the user profile database 352. Upon identifying at least one user authentication profile, the IAM system 360 can transmit the authentication profile and a positive indicator to the network server 302, confirming that the requesting user is authorized to access, allocate, and/or deallocate network resources for running application services 328 (e.g., network hosted services, an API call, and/or the like). In some implementations, the IAM system 360 can be communicatively coupled to a computing database that is separate from the network database 304. Accordingly, the IAM system 360 can use the set of identification parameters to search for the at least one user authentication profile from the separate computing database.

In other implementations, the IAM system 360 can be configured as a central repository comprising identification and authorization related information for users of network hosted application services 328. In some implementations, the IAM system 360 can be configured to perform auxiliary validation features to ensure that user authentication profiles comply with resource usage limitations imposed by an enterprise subscriber (e.g., an application developer, a network service provider, and/or the like). In certain implementations, the IAM system 360 can be configured as a component system of the resource allocation system 300. In additional or alternative implementations, the IAM system 360 can be configured as an independent system (e.g., separate from the resource allocation system 300) that is communicatively coupled to the system 300.

In other implementations, components of the network server 302 can be communicatively coupled to a charging system 370. The network server 302 can configure the charging system 370 to track allocation and usage of network resources by end-users of applications 328 administered by enterprise subscribers. Accordingly, the charging system 370 can be configured to ensure generation of accurate resource usage reports and to mitigate overuse of resources. As an example, the charging system 370 can be configured to monitor, in real time, usage metrics (e.g., resource usage duration, size of data consumption, and/or the like) of network services (e.g., APIs, applications, network slices, and/or the like) by a user device 104. Further, the charging system 370 can be configured to collect usage data. In some implementations, the charging system 370 can be configured to validate end-user compliance with resource usage limitations by comparing end-user resource usage to authorized usage limitations set by the enterprise subscriber. In certain implementations, the charging system 370 can be configured as a component system of the resource allocation system 300. In additional or alternative implementations, the charging system 370 can be configured as an independent system (e.g., separate from the resource allocation system 300) that is communicatively coupled to the system 300. In some implementations, the charging system 370 can be communicatively coupled to a computing database that is separate from the network database 304.

In additional or alternative implementations, components of the network server 302 can be communicatively coupled to a billing system 380. The network server 302 can configure the billing system 380 to manage invoices and financial transactions related to the usage of network resources by end-users and enterprise subscribers. For example, the billing system 380 can be configured to generate an invoice for a liable entity (e.g., enterprise subscriber, end-user, and/or the like) based on usage data collected from the charging system 370. In some implementations, the billing system 380 can be configured to record financial transactions at designated billing profiles of liable entities. In certain implementations, the billing system 380 can be configured as a component system of the resource allocation system 300. In additional or alternative implementations, the billing system 380 can be configured as an independent system (e.g., separate from the resource allocation system 300) that is communicatively coupled to the system 300. In some implementations, the billing system 380 can be communicatively coupled to a computing database that is separate from the network database 304.

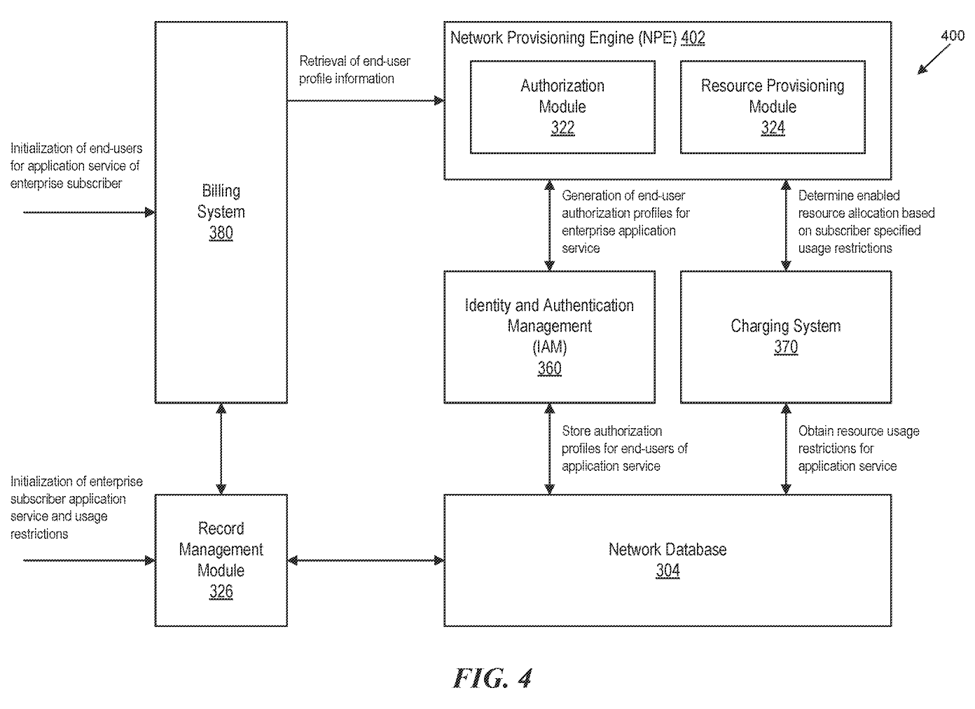

FIG. 4 is a block diagram that illustrates a process for provisioning network resources in some implementations. The process 400 can be performed by a system (e.g., a resource allocation system 300) configured to initialize application services 328 and user authentication profiles at the network database 304. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400. In some implementations, the methods described herein with respect to the process 400 can be performed via a network provisioning engine 402 of the system 300. As an illustrative example, the network provisioning engine 402 can comprise the authorization module 322 and the resource provisioning module 324 of the system 300. Although not explicitly shown in FIG. 4, the network provisioning engine 402 can also comprise the record management module 326.

As shown in FIG. 4, the system 300 can be configured to store a subscription profile of an enterprise subscriber (e.g., an application developer) at a remote hosting system (e.g., a telecommunications network). For example, the record management module 326 can be configured to receive a subscription profile comprising identifiable information corresponding to an enterprise subscriber (e.g., a developer, an application service provider, and/or the like) of the hosting system. In some implementations, the identifiable subscription information can include a subscription identifier (e.g., a network provider number, a service platform number, and/or the like), a hardware certification (e.g., a stock keeping unit number for subscriber identity modules), or a set of registration numbers (e.g., Integrated Circuit Card Identification (ICCID) and/or International Mobile Subscriber Identity (IMSI) numbers for subscriber identity modules). In some implementations, the subscription profile can comprise a set of service features (e.g., an API call, a data transfer, and/or other network provider services) of the hosting system that the enterprise subscriber is authorized to dynamically allocate for end-users (e.g., via wireless devices 104) of one or more application services. In further implementations, the subscription profile can comprise a custom billing structure (e.g., associated with the billing system 380) corresponding to one or more service features used by the enterprise subscriber to run application services at the hosting system. In additional or alternative implementations, the record management module 326 can be configured to store the received subscription profile at the enterprise subscriber database 350 of the network database 304.

The system 300 can be configured to initialize an application service of the enterprise subscriber at the remote hosting system. For example, the record management module 326 can be configured to receive a request from the enterprise subscriber to host an application and/or application features at the hosting system. In some implementations, the request from the enterprise subscriber can include one or more deployable applications (e.g., executable at the network service) submitted by the enterprise subscriber. Accordingly, the record management module 326 can be configured to store the received applications at the application service database 354 of the network database 304.

In other implementations, the record management module 326 can be configured to receive a custom billing structure (e.g., associated with the billing system 380) for one or more features of the submitted deployable application, which can be stored and/or updated at the subscription profile of the enterprise subscriber. As an illustrative example, the record management module 326 can receive a custom billing configuration (e.g., from the enterprise subscriber) for an application service 328 that partitions the accumulated costs of allocating resources (e.g., network service features) between a first liable entity (e.g., an end-user of the application services) and a second liable entity (e.g., the enterprise subscriber). In some implementations, the record management module 326 can be configured to receive, and store, a set of resource allocation restrictions (e.g., end-user usage limitations) from the enterprise subscriber for running application services at the hosting system. For example, the set of resource allocation restrictions (e.g., usage preference parameters) can include acceptable thresholds for allocation duration (e.g., a maximum resource usage time), allocation size (e.g., a maximum data transfer size), and other applicable parameters for measuring resource consumption. In additional or alternative implementations, the record management module 326 can be configured to receive, and store, a set of authorization parameters (e.g., a list of qualified users, a set of user permissions) that define external users authorized to allocate resources for running one or more application services 328.

The system 300 can be configured to initialize end-users of the remote hosted application services 328. For example, the system 300 can be configured to receive a permissions request from an external user to allocate resources for running one or more application services 328 at the remote hosting system. In some implementations, the request from the external user can comprise identifiable user information, such as an application identifier (e.g., a process number, an application name, and/or the like), an enterprise subscriber identifier (e.g., a subscriber number), a Mobile Station International Subscriber Directory Number (MSISDN), or a set of registration numbers (e.g., ICCID and/or IMSI numbers). Using the identifiable user information, the system 300 can be configured to provision a billing profile for the requesting user at the billing system 380.

In other implementations, the system 300 can be configured to generate, and store, a user authentication profile (e.g., for a requesting end-user) comprising permissions information for enabling allocation of resources to run the one or more application services 328. For example, the authorization module 322 can be configured to access identifiable user information (e.g., a validated MSISDN, a subscriber identifier, an application identifier, and/or the like) for the requesting user from the billing system 380. Using the identifiable user information, the resource provisioning module 324 can be configured to obtain a set of resource allocation restrictions (e.g., specified by an enterprise subscriber) for an application service 328 specified in the user request (e.g., via an application identifier). Accordingly, the resource provisioning module 324 can evaluate and/or compare the identifiable user information to the resource allocation restrictions to determine a set of authorized (e.g., or unauthorized) application features accessible to the requesting user. In particular, the authorization module 322 can be configured to store, at the user profile database 352, a custom authorization profile that enables the requesting user to allocate resources for running the set of authorized application features. In some implementations, the resource provisioning module 324 can store the set of authorized application features at the charging system 370.

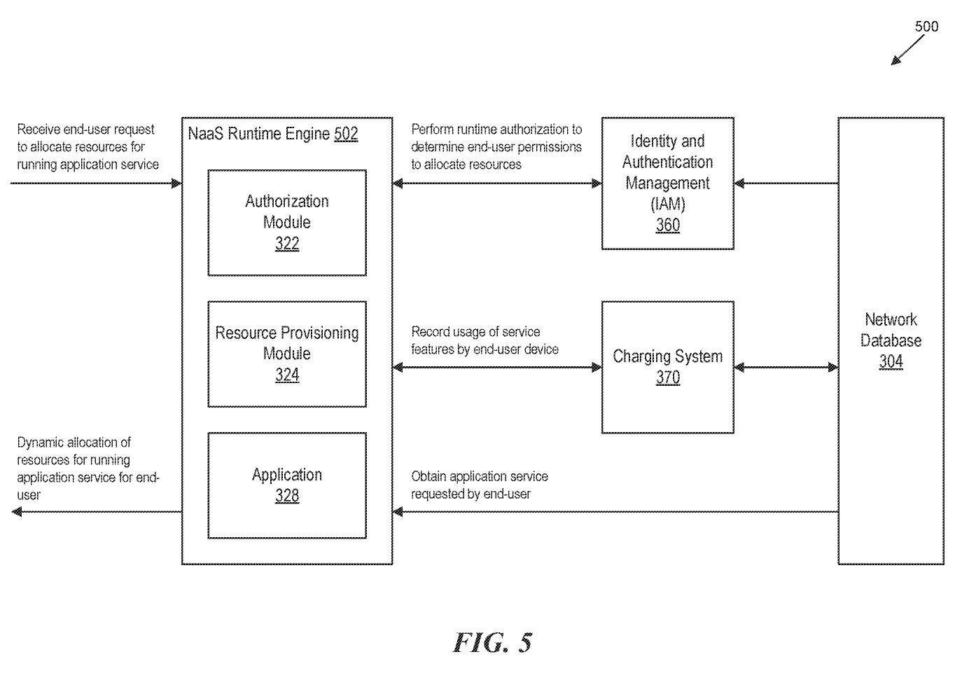

FIG. 5 is a block diagram that illustrates a process for dynamic network resource allocation in some implementations. The process 500 can be performed by a system (e.g., a resource allocation system 300) configured to dynamically allocate resources for running application services 328. In one example, the system includes at least one hardware processor and at least one non-transitory memory storing instructions, which, when executed by the at least one hardware processor, cause the system to perform the process 500. In another example, the system includes a non-transitory, computer-readable storage medium comprising instructions recorded thereon, which, when executed by at least one data processor, cause the system to perform the process 500. In some implementations, the methods described herein with respect to the process 500 can be performed via a network-as-a-service (NaaS) runtime engine 502 of the system 300. As an illustrative example, the NaaS runtime engine 502 can comprise the authorization module 322, the resource provisioning module 324, and the runtime application services 328 of the system 300.

As shown in FIG. 5, the system 300 can be configured to receive a request from an end-user (e.g., via wireless device 104) for allocating resources (e.g., network service features) to run one or more applications 328 administered by an enterprise subscriber at a hosting system (e.g., telecommunications network). For example, the authorization module 322 can be configured to receive an allocation request from an end-user comprising identifiable user information (e.g., a validated MSISDN, a subscriber identifier, an application identifier, and/or the like). Using the identifiable user information, the authorization module 322 can retrieve an authorization profile (e.g., or a plurality of authorization profiles) corresponding to the user from the user profile database 352. In some implementations, the request from the end-user can comprise a usage estimate (e.g., anticipated costs for network service, approximate duration of resource consumption) for allocating required resources to run the specified applications 328. In additional or alternative implementations, the authorization module 322 can use the IAM system 360 to validate the identifiable user information from the end-user request.

The system 300 can be configured to perform an authorization procedure (e.g., at runtime) to verify an end-user is authorized to allocate resources to run the specified applications 328. For example, the authorization module 322 can be configured to use the retrieved authorization profile of the end-user to determine a set of service features (e.g., network service features) enabled for the end-user. In some implementations, the authorization module 322 can use the retrieved authorization profile of the end-user to identify a set of service features disabled for the end-user. Using the identified set of service features that are enabled (e.g., or disabled) for the end-user, the authorization module 322 can determine whether the requesting end-user has sufficient permissions to allocate resources for running a remote hosted application 328. In further implementations, the authorization module 322 can be configured to evaluate the resource usage estimate of the end-user request to determine compliance with one or more resource allocation restrictions specified by the enterprise subscriber. In additional or alternative implementations, the authorization module 322 can use multiple authorization profiles to determine different combinations of service features enabled for the end-user.

The system 300 can be configured to dynamically allocate (e.g., or deallocate) resources authorized for use by the requesting end-user. For example, the resource provisioning module 324 can allocate (e.g., at runtime) one or more service features (e.g., network service features) for running a user-specified application 328 in response to determining the end-user is authorized to use the service features. Accordingly, the resource provisioning module 324 can deploy a corresponding application 328 that is stored at the application service database 354. Further, the resource provisioning module 324 can deny allocation of one or more service features for running the application 328 in response to determining the end-user is not authorized to use the service features. In additional or alternative implementations, the resource provisioning module 324 can be configured to record (e.g., via APIs) real-time usage of allocated resources (e.g., network service features) at the charging system 370. For example, the resource provisioning module 324 can generate, at the charging system 370, a resource usage record corresponding to the end-user, such that the resource usage record is accessible by an enterprise subscriber of the application 328.

The system 300 can be further configured to monitor fluctuations in end-user authorization for resource allocation. For example, the authorization module 322 can detect when an end-user has exhausted at least one resource usage restriction for service features specified by the enterprise subscriber. In response, the resource provisioning module 324 can dynamically deallocate the service features available to the end-user. In some implementations, the resource provisioning module 324 can further reallocate the service features to another end-user authorized to use the application 328.

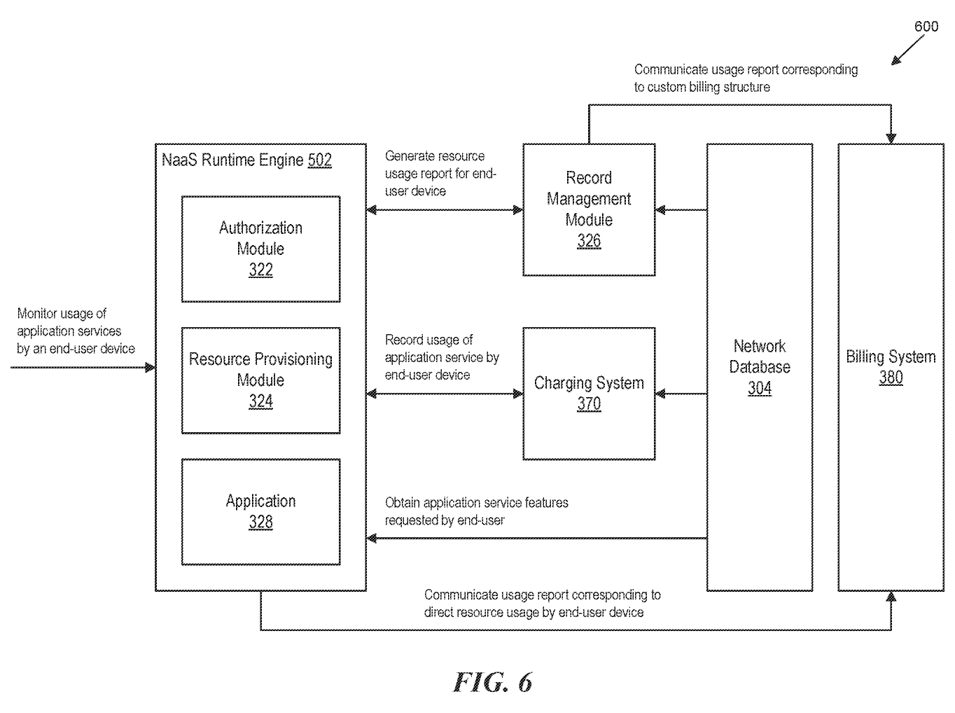

FIG. 6 is a block diagram that illustrates a process for generating resource usage reports in some implementations. The process 600 can be performed by a system (e.g., a resource allocation system 300) configured to monitor resource consumption for running application services 328. In one example, the system includes at least one hardware processor and at least one non-transitory memory storing instructions, which, when executed by the at least one hardware processor, cause the system to perform the process 600. In another example, the system includes a non-transitory, computer-readable storage medium comprising instructions recorded thereon, which, when executed by at least one data processor, cause the system to perform the process 600. In some implementations, the methods described herein with respect to the process 600 can be performed via the NaaS runtime engine 502 of the system 300. As an illustrative example, the NaaS runtime engine 502 can comprise the authorization module 322, the resource provisioning module 324, and the runtime application services 328 of the system 300.

As shown in FIG. 6, the system 300 can be configured to monitor active resource usage of an end-user for running an application 328 at the hosting system (e.g., telecommunications network). For example, the resource provisioning module 324 can be configured to instantiate a charging session at the charging system 370 for monitoring real-time resource usage by the end-user to run the application 328. Accordingly, the resource provisioning module 324 can continuously monitor and record the resource usage (e.g., usage duration, resource consumption size, and/or the like) of the end-user during the charging session.

In some implementations, the system 300 can validate end-user allocation of resources prior to initialization of the charging session. For example, the authorization module 322 can evaluate the compliance of end-user permissions (e.g., via a corresponding user authorization profile) for allocating service features to a custom billing structure specified by the enterprise subscriber. In other implementations, the authorization module 322 can evaluate compliance of an estimated resource usage by the end-user device in comparison to one or more usage restrictions associated with the custom billing structure. By comparing the estimated resource usage to the usage restrictions, the resource provisioning module 324 can determine an estimated remaining resource usage available to the end-user for running the application 328. The resource provisioning module 324 can further restrict (e.g., or permit) one or more service features in response to the estimated remaining resource usage for the end-user.

The system 300 can be configured to communicate a usage report to the billing system 380 of the enterprise subscriber that administered the application 328. For example, the record management module 326 can be configured to generate a diagnostic usage report comprising an indication of the usage duration, the total data usage, and/or other resource consumption metrics associated with the end-user. In some implementations, the record management module 326 can generate the usage report based on a predetermined relationship between resources (e.g., network service features) used by the end-user and the custom billing structure (e.g., a cost rate per usage, liable entities for specified resource costs). The record management module 326 can be further configured to simultaneously record the resource usage at the charging system 370 and generate the usage report for the billing system 380. In additional or alternative implementations, the record management module 326 can be configured to generate the usage report directly based on the total resource usage by the end-user.

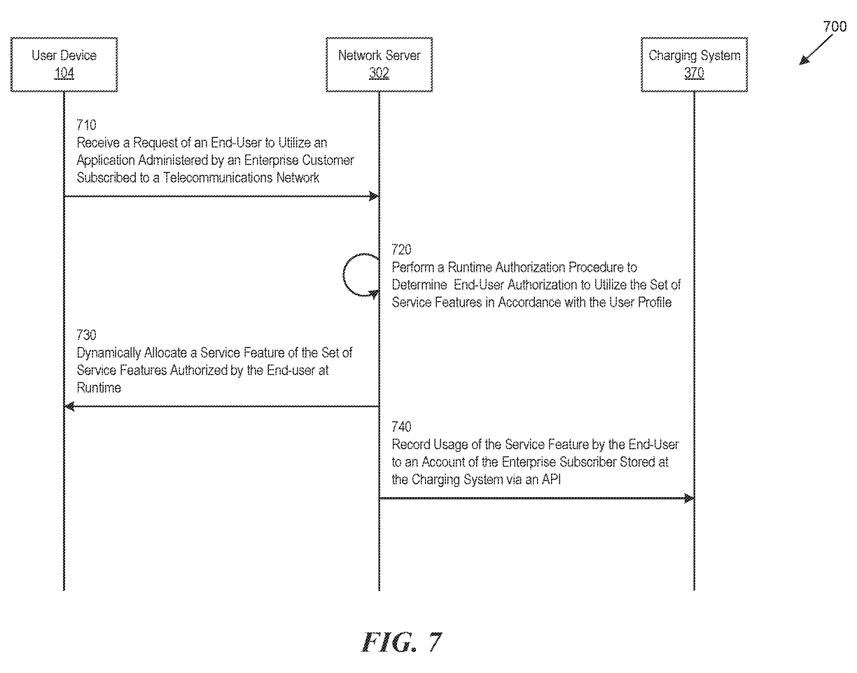

FIG. 7 is a flow diagram that illustrates a process to dynamically allocate application services in some implementations. The process 700 can be performed by a system (e.g., a resource allocation system 300) configured to allocate network resources (e.g., a runtime application service) for use by authorized user devices. In one example, the system includes at least one hardware processor and at least one non-transitory memory storing instructions, which, when executed by the at least one hardware processor, cause the system to perform the process 700. In another example, the system includes a non-transitory, computer-readable storage medium comprising instructions recorded thereon, which, when executed by at least one data processor, cause the system to perform the process 700.

At 710, the system can receive a request of an end-user to utilize an application administered by an enterprise customer subscribed to a telecommunications network through which the application is hosted such that a subscription of the enterprise subscriber includes a set of service features of the telecommunications network that are dynamically allocatable to end-users of the application. In some implementations, the request identifies the application, a user profile for accessing the application, or an indication of an anticipated usage value.

At 720, the system can perform an authorization procedure to determine whether the end-user is authorized to utilize the set of service features in accordance with the user profile and based on preference parameters set for the enterprise subscriber. In some implementations, the system can perform the authorization procedure as a runtime process in response to receiving the request of the end-user. In additional or alternative implementations, the preference parameters of the enterprise subscriber can include an indication of authorized end-users and usage restrictions for the set of service features. In other implementations, the system can identify one or more service features of the set of service features that are authorized for the user profile such that multiple user profiles authorize different combinations of the set of service features of the telecommunications network to end-users of the application.

At 730, the system can dynamically allocate a service feature of the set of service features authorized for use by the end-user. In some implementations, the system can allocate the service feature as a runtime process in response to determining that the end-user is authorized to utilize the set of service features. In additional or alternative implementations, the system can execute one or more processes prior to allocation of the service feature. For example, the system can validate an identifier of the application and the profile included in the request via an identity and authentication management component of the telecommunications network. As another example, the system can identify the end-user as an authorized end-user based on a Mobile Station International Subscriber Directory Number (MSISDN) of multiple MSISDNs for the authorized end-users.

In some implementations, the system can receive a first request for a first end-user and a second request for a second end-user. In response to receiving the second request, the system can perform the authorization procedure, at runtime, to determine whether a second end-user is authorized to utilize the set of service features in accordance with the user profile and based on parameters integrated into the application at development. In response to determining that the second end-user is not authorized to utilize the set of service features, the system can deny the second end-user from utilizing the application.

At 740, the system can record, via an application programming interface (API) of a charging system of the telecommunications network, usage of the service feature by the end-user to an account of the enterprise subscriber stored at the charging system of the telecommunications network. In some implementations, the system can determine, by the charging system, that the anticipated usage value for the service feature does not exceed a usage restriction for the service feature, wherein the usage value includes a time component. In other implementations, the system can dynamically deallocate, at runtime, the service feature from the end-user in response to detecting that the end-user has exhausted the usage restriction for the service feature. In additional or alternative implementations, the system can dynamically reallocate, at runtime, the service feature of the set of service features authorized for use by the end-user to another end-user authorized to use the application based on another user profile.

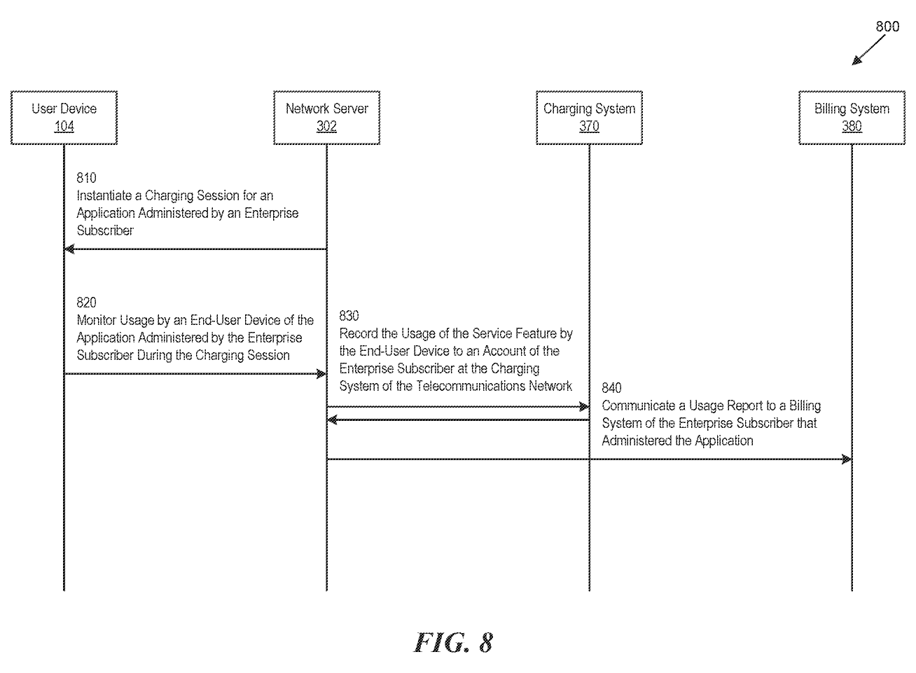

FIG. 8 is a flow diagram that illustrates a process to record usage of application services in some implementations. The process 800 can be performed by a system (e.g., a resource allocation system 300) configured to generate a custom usage report of network resources (e.g., a runtime application) for a billing system of an enterprise-level customer. In one example, the system includes at least one hardware processor and at least one non-transitory memory storing instructions, which, when executed by the at least one hardware processor, cause the system to perform the process 800. In another example, the system includes a non-transitory, computer-readable storage medium comprising instructions recorded thereon, which, when executed by at least one data processor, cause the system to perform the process 800.

At 810, the system can instantiate a charging session for an application administered by an enterprise subscriber subscribed to a telecommunications network. In some implementations, a subscription of the enterprise subscriber includes a billing structure for the set of service features customized for the enterprise subscriber or the application hosted by the enterprise subscriber. In other implementations, the telecommunications network hosts a set of service features that support the application for use by end-user devices of the application. In additional or alternative implementations, the system can dynamically allocate a service feature for use by the end-user device based on a user profile of an end-user of the end-user device such that the user profile is configured by the enterprise subscriber. In some implementations, the system can dynamically allocate the service feature for use by the end-user device based on a user profile of an end-user of the end-user device such that the user profile is configured by the enterprise subscriber.

At 820, the system can monitor usage, by an end-user device, of the application administered by the enterprise subscriber during the charging session such that the monitored usage includes at least one of duration or data usage of a service feature of the set of service features. In some implementations, the system can execute one or more processes prior to monitoring the usage of the application. For example, the system can perform an authorization procedure to determine whether the end-user device is authorized to utilize the service feature in accordance with the custom billing structure. As another example, the system can determine, by an authorization system of the telecommunications system, that the end-user device is authorized to utilize the service feature. In an alternative example, the system can identify the end-user as an authorized end-user based on a Mobile Station International Subscriber Directory Number (MSISDN) of the end-user device, an identifier of the application that is registered with the enterprise subscriber, or an indication of the charging session of the application invoked at the end-user device.

At 830, the system can record, at a charging system of the telecommunications network, the usage of the service feature by the end-user device to an account of the enterprise subscriber of the telecommunications network. In some implementations, the system can determine, by the charging system, that an anticipated usage of the service feature by the end-user device does not exceed a time-based restriction for the custom billing structure. In other implementations, the system can detect an amount of remaining usage available to the end-user device based on a usage restriction for the service feature; and in response to the detected amount of remaining usage, restrict usage of the service feature by the end-user device.

At 840, the system can communicate a usage report to a billing system of the enterprise subscriber that administered the application such that the billing system is administered separate from the charging system of the telecommunications network. In some implementations, the usage report includes an indication of the duration, the data usage, or both of the service feature by the end-user device in accordance with the custom billing structure. In other implementations, the system can simultaneously record the usage of the service feature at the charging system of the telecommunications network and communicate the usage report to the billing system of the enterprise subscriber.

### Computer System

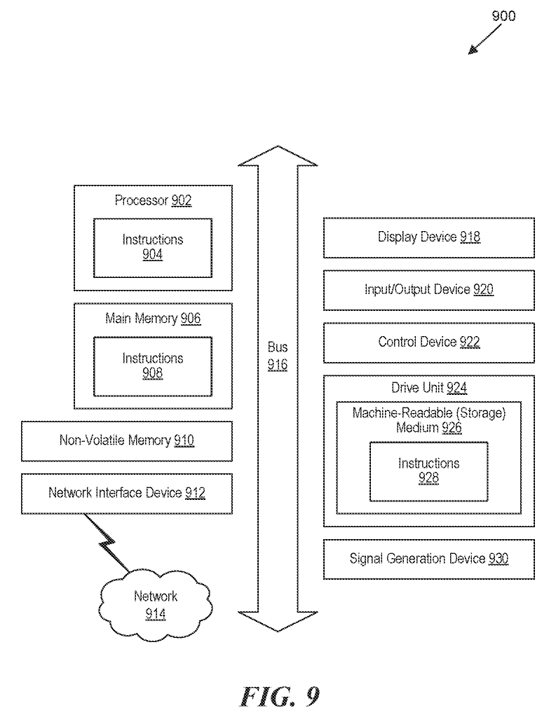

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to:
instantiate a charging session for an application administered by an enterprise subscriber subscribed to a telecommunications network,
wherein the telecommunications network hosts a set of service features that support the application for use by end-user devices of the application, and
wherein a subscription of the enterprise subscriber includes a billing structure for the set of service features customized for the enterprise subscriber or the application hosted by the enterprise subscriber;
monitor usage, by an end-user device, of the application administered by the enterprise subscriber during the charging session,
wherein the monitored usage includes at least one of duration or data usage of a service feature of the set of service features;
record, at a charging system of the telecommunications network, the usage of the service feature by the end-user device to an account of the enterprise subscriber of the telecommunications network; and
communicate a usage report to a billing system of the enterprise subscriber that administered the application,
wherein the billing system is administered separate from the charging system of the telecommunications network,
wherein the usage report includes an indication of the duration, the data usage, or both of the service feature by the end-user device in accordance with the custom billing structure.

2. The non-transitory, computer-readable storage medium of claim 1, wherein the system is further caused to:
simultaneously record the usage of the service feature at the charging system of the telecommunications network and communicate the usage report to the billing system of the enterprise subscriber.

3. The non-transitory, computer-readable storage medium of claim 1, wherein the system is further caused to, prior to the usage being monitored by the system:
perform an authorization procedure to determine whether the end-user device is authorized to utilize the service feature in accordance with the custom billing structure.

4. The non-transitory, computer-readable storage medium of claim 1, wherein the system is further caused to, prior to the usage being monitored by the system:
determine, by an authorization system of the telecommunications system, that the end-user device is authorized to utilize the service feature; and
determine, by the charging system, that an anticipated usage of the service feature by the end-user device does not exceed a time-based restriction of the custom billing structure.

5. The non-transitory, computer-readable storage medium of claim 1, wherein the system is further caused to, prior to the usage being monitored by the system:
determine, by an authorization system of the telecommunications system, that the end-user device is authorized to utilize the service feature;
detect an amount of remaining usage available to the end-user device based on usage restriction for the service feature; and
in response to the detected amount of remaining usage, restrict usage of the service feature by the end-user device.

6. The non-transitory, computer-readable storage medium of claim 1, wherein the system is further caused to, prior to monitoring usage of the service feature:
identify the end-user as an authorized end-user based on one or more of:
a Mobile Station International Subscriber Directory Number (MSISDN) of the end-user device,
an identifier of the application, wherein the identifier is registered with the enterprise subscriber, or
an indication of the charging session of the application invoked at end-user device.

7. The non-transitory, computer-readable storage medium of claim 1, wherein the system is further caused to:
dynamically allocate the service feature for use by the end-user device based on a user profile of an end-user of the end-user device,
wherein the user profile is configured by the enterprise subscriber.

8. A resource allocation system comprising:
at least one hardware processor; and
at least one non-transitory memory storing instructions, which, when executed by the at least one hardware processor, cause the resource allocation system to:
instantiate a charging session for an application administered by an enterprise subscriber subscribed to a telecommunications network,
wherein the telecommunications network hosts a set of service features that support the application for use by end-user devices of the application, and
wherein a subscription of the enterprise subscriber includes a billing structure for the set of service features customized for the enterprise subscriber or the application hosted by the enterprise subscriber;
monitor usage, by an end-user device, of the application administered by the enterprise subscriber during the charging session,
wherein the monitored usage includes at least one of duration or data usage of a service feature of the set of service features;
record, at a charging system of the telecommunications network, the usage of the service feature by the end-user device to an account of the enterprise subscriber of the telecommunications network; and
communicate a usage report to a billing system of the enterprise subscriber that administered the application,
wherein the billing system is administered separate from the charging system of the telecommunications network,
wherein the usage report includes an indication of the duration, the data usage, or both of the service feature by the end-user device in accordance with the custom billing structure.

9. The resource allocation system of claim 8 further caused to:
simultaneously record the usage of the service feature at the charging system of the telecommunications network and communicate the usage report to the billing system of the enterprise subscriber.

10. The resource allocation system of claim 8 further caused to, prior to the usage being monitored by the system:
perform an authorization procedure to determine whether the end-user device is authorized to utilize the service feature in accordance with the custom billing structure.

11. The resource allocation system of claim 8 further caused to, prior to the usage being monitored by the system:
determine, by an authorization system of the telecommunications system, that the end-user device is authorized to utilize the service feature; and
determine, by the charging system, that an anticipated usage of the service feature by the end-user device does not exceed a time-based restriction of the custom billing structure.

12. The resource allocation system of claim 8 further caused to, prior to the usage being monitored by the system:
determine, by an authorization system of the telecommunications system, that the end-user device is authorized to utilize the service feature;
detect an amount of remaining usage available to the end-user device based on usage restriction for the service feature; and
in response to the detected amount of remaining usage, restrict usage of the service feature by the end-user device.

13. The resource allocation system of claim 8 further caused to, prior to monitoring usage of the service feature:
identify the end-user as an authorized end-user based on one or more of:
a Mobile Station International Subscriber Directory Number (MSISDN) of the end-user device,
an identifier of the application, wherein the identifier is registered with the enterprise subscriber, or
an indication of the charging session of the application invoked at end-user device.

14. The resource allocation system of claim 8 further caused to:
dynamically allocate the service feature for use by the end-user device based on a user profile of an end-user of the end-user device,
wherein the user profile is configured by the enterprise subscriber.

15. A method performed by a resource allocation system, the method comprising:
instantiating a charging session for an application administered by an enterprise subscriber subscribed to a telecommunications network,
wherein the telecommunications network hosts a set of service features that support the application for use by end-user devices of the application, and
wherein a subscription of the enterprise subscriber includes a billing structure for the set of service features customized for the enterprise subscriber or the application hosted by the enterprise subscriber;
monitoring usage, by an end-user device, of the application administered by the enterprise subscriber during the charging session,
wherein the monitored usage includes at least one of duration or data usage of a service feature of the set of service features;
recording, at a charging system of the telecommunications network, the usage of the service feature by the end-user device to an account of the enterprise subscriber of the telecommunications network; and
communicating a usage report to a billing system of the enterprise subscriber that administered the application,
wherein the billing system is administered separate from the charging system of the telecommunications network,
wherein the usage report includes an indication of the duration, the data usage, or both of the service feature by the end-user device in accordance with the custom billing structure.

16. The method performed by the resource allocation system of claim 15, the method further comprising:
simultaneously recording the usage of the service feature at the charging system of the telecommunications network and communicate the usage report to the billing system of the enterprise subscriber.

17. The method performed by the resource allocation system of claim 15, the method further comprising:
performing, prior to monitoring the usage of the application, an authorization procedure to determine whether the end-user device is authorized to utilize the service feature in accordance with the custom billing structure.

18. The method performed by the resource allocation system of claim 15, the method further comprising:
determining, by an authorization system of the telecommunications system prior to monitoring the usage of the application, that the end-user device is authorized to utilize the service feature; and
determining, by the charging system, that an anticipated usage of the service feature by the end-user device does not exceed a time-based restriction of the custom billing structure.

19. The method performed by the resource allocation system of claim 15, the method further comprising:
determining, by an authorization system of the telecommunications system prior to monitoring the usage of the application, that the end-user device is authorized to utilize the service feature;
detecting an amount of remaining usage available to the end-user device based on usage restriction for the service feature; and
in response to the detected amount of remaining usage, restricting usage of the service feature by the end-user device.

20. The method performed by the resource allocation system of claim 15, the method further comprising:
dynamically allocating the service feature for use by the end-user device based on a user profile of an end-user of the end-user device,
wherein the user profile is configured by the enterprise subscriber.
